(19) United States
(12) Patent Application Publication
(10) Pub. No.: US 2009/0159199 A1
(43) Pub. Date: Jun. 25, 2009

(54) METHOD AND DEVICE FOR APPLICATION OF SELF-ADHESIVE FOIL

(76) Inventor: Peter Fiehl Jensen, Copenhagen (DK)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/160,231

(22) PCT Filed: Dec. 8, 2006
(86) PCT No.: PCT/DK06/00700

§ 371 Date: Nov. 6, 2008

(30) Foreign Application Priority Data
Jan. 10, 2006 (DK) PA 2006 00043

(51) Int. Cl. B32B 37/12

(52) U.S. Cl. 156/289; 156/577

(57) ABSTRACT

A method and an apparatus (2) for mounting self-adhesive foil (19) which is provided with a liner (21) treated with anti-seize material, where a transverse cut is performed in the liner (21) at a short distance from a free end edge (37) of the foil (19). The self-adhesive foil (19) is rolled in a roll with a front side of the foil (19) facing outwards, and with the upper part of the image on the foil disposed at the free edge (37) of the roll. The free edge (37) of the foil (19) is fixed externally on an application apparatus (2). The foil roll is placed in the application apparatus (2) with the free end of the roll passed out of the apparatus through an outlet before closing and fixing a lid (12) over an inlet aperture (18). The liner (21) is released from the foil (19) below the transverse cut. The upper part of the foil is disposed in the desired position of application. A plane top side (27) of the application apparatus (2) is preferably used as a guide, whereafter the foil is transferred under pressure against the surface of application and simultaneously with downward movement of the application apparatus (2). The foil is mounted in stretched position on the application surface, while the liner (21) is continuously released from the foil (19).

### BACKGROUND OF THE INVENTION

1. Field of the Invention

The present invention concerns a method for mounting self-adhesive foil.

The invention also concerns an apparatus for use in mounting self-adhesive foil by the method according to the invention.

2. Description of the Prior Art

When mounting self-adhesive foils, it is very difficult to avoid air pockets or bubbles and folds being formed under the foil during the mounting. In order to eliminate or avoid formation of such air bubbles or folds, it is known to use various forms of scrapers with sharp edges to smoothen the foil and to displace the air bubbles to an edge of the foil in order to remove the bubbles, as possible folds are difficult to remove. At the same time, care is required during the mounting in order not to damage the foil, which all things considered requires cumbersome and time-consuming work to mount larger self-adhesive foils.

U.S. Pat. No. 3,737,360 discloses a portable device adapted to be operated by hand and in the nature of a dispenser or applicator for applying self-adhesive material, especially plastic self-adhesives, to a flat surface from a source of supply wherein the self-adhesive plastic material is characterized by a removable paper backing or the like, which is to be stripped away from the self-adhesive plastic at the time of application of such plastic to the surface to be covered thereby.

U.S. Pat. No. 3,861,988 discloses an applicator tube having a longitudinal side slot containing a roll of pressure sensitive sheeting with a backing strip, that is extended through the slot and manually separated for a small distance; the exposed bare sheeting is initially adhered to the starting point on the flat surface. A compressible pressure bar protrudes outwardly from the external face of the tube at the edge of the slot and is enclosed by a smooth covering whose ends are joined and extend inwardly through the slot and fixed therealong to the internal face of the tube. By moving the applicator tube the backing strip is automatically separated without need of pulling by hand, as the stripped paper is pulled from the roll in the tube over the covered slot edge and compressible pressure bar and adhered thereby to the flat surface.

### SUMMARY OF THE INVENTION

The invention is a method and an apparatus, which in a simple way and by means of simple measures enables mounting of self-adhesive foils without the occurrence of the drawbacks.

The method according to the invention is characterised in that a transverse cut is performed in the liner at a short distance from a free end edge of the foil, that the self-adhesive foil is rolled up to form a roll with the front side of the foil facing outwards in the roll, and with the upper part of the image on the foil disposed at the free edge of the roll, the free edge of the foil is fixed externally on an application apparatus, the foil roll is placed in the application apparatus with the free end of the roll passed out of the application apparatus through an outlet aperture or slot before closing and fixing a lid over an inlet aperture, the liner is released from the foil below the transverse cut, and the upper part of the foil is disposed in the desired position of application, as a plane top side of the application apparatus is preferably used as an aiming means, whereafter the foil is transferred under pressing contact against the surface of application and simultaneous downward movement of the application apparatus, and the foil being mounted in stretched position on the application surface as the liner is concurrently released from the foil.

In a simple way it is hereby enabled to mount self-adhesive foil in an entirely new way which at the same time ensures an entirely smooth mounting of the foil, that is without formation of air bubbles under the foil.

The method according to the invention may suitably be modified in that the fixing of the free edge of the foil externally on the application apparatus is performed by inserting the free edge under a longitudinal edge part, whereafter the free edge of the foil is clamped by means of a longitudinal edge part of an outwardly spring biased fixing plate member.

With regard to enhance the method according to the invention, it may be a further advantage that the fixing plate member is locked at opposite ends by means of resilient locking fingers that engage over opposite end edges of the fixing plate member, and which are integrated in end covers of an apparatus housing so that the free edge of the foil is securely fixed under the firm longitudinal edge by means of the longitudinal edge part.

In order to ensure efficient closing of the application apparatus during the mounting, it may furthermore be expedient that the fixing of the lid is performed by means of resilient locking fingers that engage over opposing end edges of the lid and which are integrated in end covers of the apparatus housing.

With the object of enhancing the action of pressing during the mounting, it may be advantageous that the pressing contact against the surface of application is effected by means of a pressing surface with a felt coating in the form of the fixing plate member, as the pressing contact is made resilient, for example, by means of sponge rubber disposed between the fixing plate member and the felt coating.

The invention also concerns an application apparatus for mounting or applying self-adhesive foil which is provided with a liner treated with anti-seize, the application apparatus including an elongated apparatus housing, the application apparatus including a longitudinal inlet aperture for inserting a rolled-up self-adhesive foil which is rolled up with the front side of the foil facing outwards in the roll and with an upper part of the image on the foil disposed at a free end edge of the roll, the application apparatus further including a longitudinal outlet slot for passing out the free edge of the foil for fixing the free edge of the foil by means of fixing means at an external face section of the application apparatus, and which furthermore includes a longitudinal edge part about which the foil can be passed for continuously releasing the liner from the foil, which application apparatus at the face section includes means for pressing to ensure simultaneous pressing and smoothing of the foil against a position of application during downwards movement of the application apparatus.

Suitably, the apparatus according to the invention has the means for fixing including a longitudinal fixed edge part below which the free end edge of the foil can be inserted, and a longitudinal edge part interacting therewith an outwardly spring biased plate fixing member.

With the intention of countering inadvertent release of the free end edge of the foil, the apparatus according to the invention may have the fixing plate member arranged to be locked at opposing ends by resilient locking fingers that engage over opposite end edges of the fixing plate fixing member and which are integrated in end covers of an apparatus housing.

In order to ensure good functioning of the apparatus according to the invention, it may be advantageous that the end covers of the apparatus housing additionally include an integrated spring-biased lock finger which engages over opposite end edges of the lid.

In order to enhance the effect of pressing the foil against the mounting base, it may be further advantageous that for exerting the pressing contact against the surface of application, a pressing surface is provided with a felt covering in the form of the fixing plate member, which is made resilient for example by sponge rubber disposed between the fixing plate member and the felt covering.

### BRIEF DESCRIPTION OF THE DRAWINGS

The invention is explained more closely in the following with reference to the drawing, on which:

FIG. 1 shows a perspective view of a preferred embodiment of an apparatus according to the invention, as seen from an end part thereof;

FIG. 2 shows a perspective view of an aluminium profile forming an elongated apparatus housing of the apparatus according to the invention;

FIG. 3 shows a perspective view of the right end cover in the situation of use for an apparatus housing for an apparatus, shown in FIG. 1, according to the invention, as seen from the outside;

FIG. 4 shows a plane view of the end cover, shown in FIG. 3, as seen from the inside;

FIG. 5 shows a perspective view of the left end cover in the situation of use for an apparatus housing for an apparatus, shown in FIG. 1, according to the invention, as seen from the outside;

FIG. 6 shows a plane view of the end cover, shown in FIG. 5, as seen from the inside;

FIG. 7 shows a perspective view of a lid for an apparatus housing, shown in FIG. 12, for an apparatus, shown in FIG. 1, according to the invention;

FIG. 8 shows a perspective view of a combined pressing face and fixing part for an apparatus, shown in FIG. 1, according to the invention;

FIG. 9 shows a perspective view of a pressing body for mounting externally on the fixing part, shown in FIG. 8;

FIG. 10 shows a perspective view for illustrating of how the lid, shown in FIG. 7, is released from the engagement with lock fingers of the end covers, shown in FIGS. 4-6;

FIG. 11 shows a perspective view for illustrating of how the fixing part, shown in FIG. 8, is pressed downwards for locking by means of locking fingers of the end covers, shown in FIGS. 4-6;

FIG. 12 shows a perspective view for illustrating how a transverse cut is performed in the liner at a short distance from an upper transverse end edge of the foil, which appears with the liner facing upwards;

FIG. 13 shows a perspective view for illustrating how the foil is rolled into a roll from the bottom and with the print side facing outwards in the roll;

FIG. 14 shows a perspective view for illustrating how the free transverse top side edge of the foil is inserted and fixed by means of the fixing plate, shown in FIG. 8;

FIG. 15 shows a perspective view for illustrating how the rolled up foil is inserted through the open lid, which is closed subsequently;

FIG. 16 shows a perspective view for illustrating how the fixing plate is loosened from its engagement with locking fingers in both end covers;

FIG. 17 shows a perspective view for illustrating how the liner is released from an upper transverse part of the foil;

FIG. 18 shows a perspective view for illustrating the mounting itself of the foil on a smooth surface, in this case at the exterior of a glass door, where the top side of the apparatus is disposed horizontally by means of a spirit level at the underside of apparatus, before its top side is pressed against the surface, whereby the fixing plate releases the top side edge of the foil;

FIG. 19 shows how the apparatus is then moved slowly downwards under simultaneous mounting of the foil and concurrent release of the liner;

FIG. 20 shows how the narrow liner part is removed from the top side edge of the foil;

FIG. 21 shows how the felt covered fixing plate is used finally for smoothing the top side edge of the mounted foil;

FIG. 22 shows a perspective view of a preferred embodiment of an apparatus according to the invention, shown with the lid facing upwards and with the fixing plate facing forwards;

FIG. 23 shows a perspective view of an apparatus, shown in FIG. 22, with open lid; and

FIG. 24 shows a plane view, partly in section, of the preferred embodiment of an apparatus according to the invention.

### DESCRIPTION OF THE INVENTION

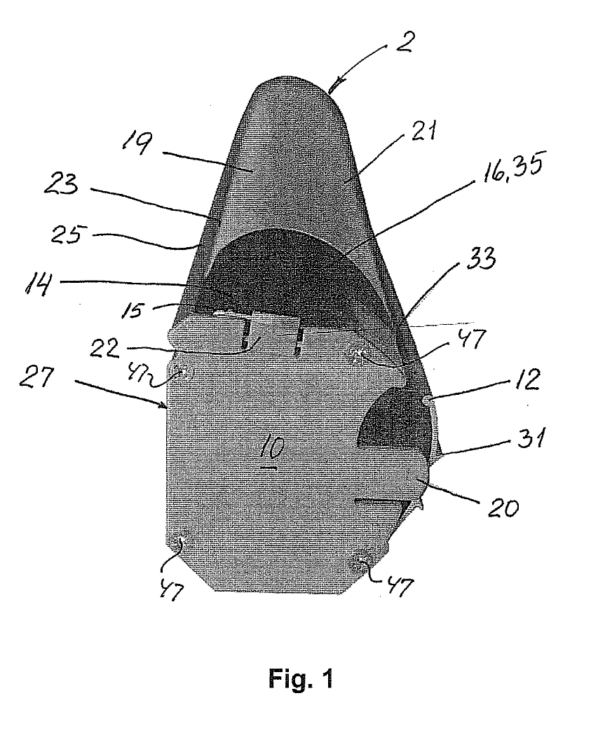

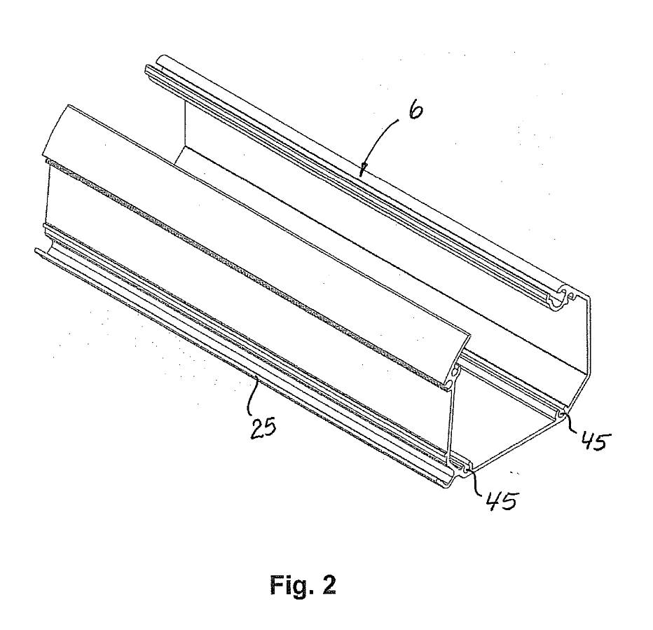

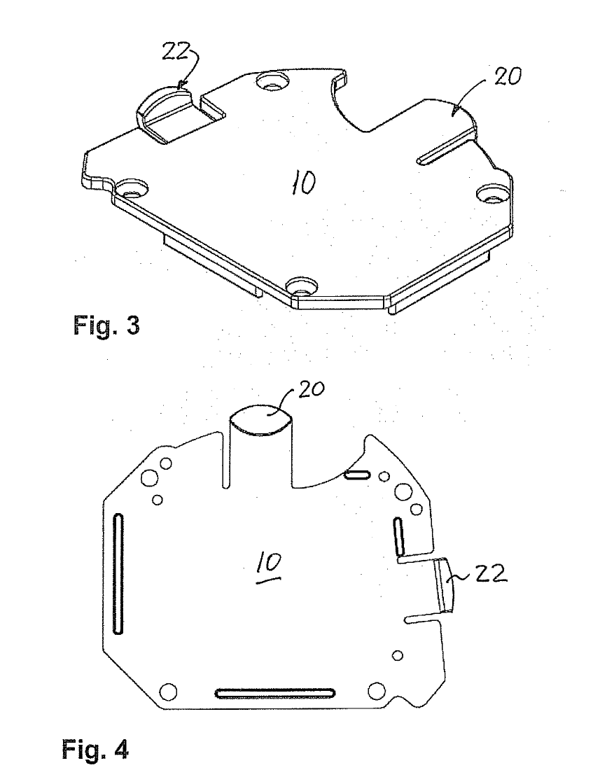

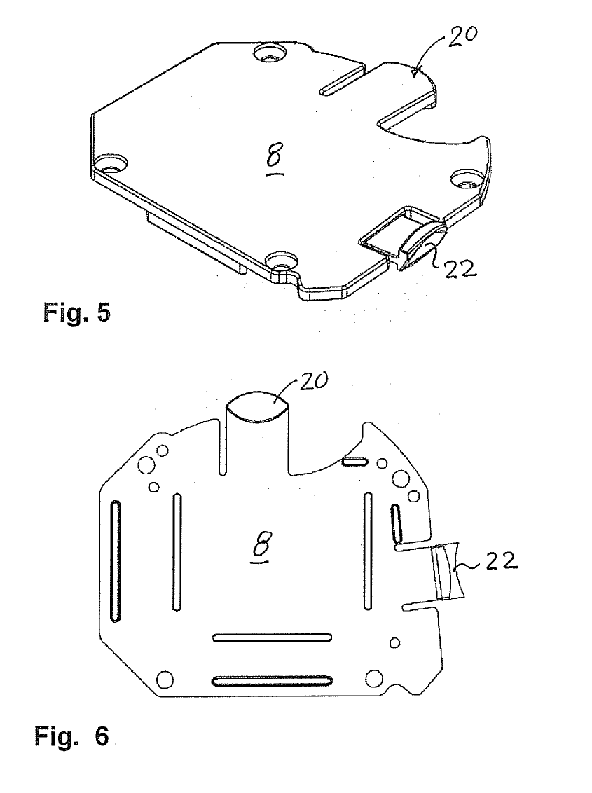

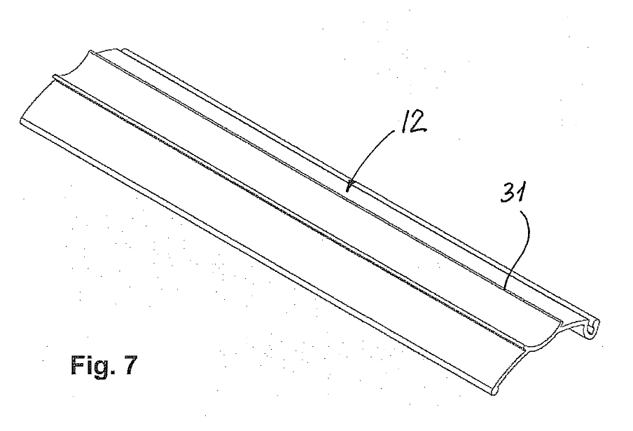

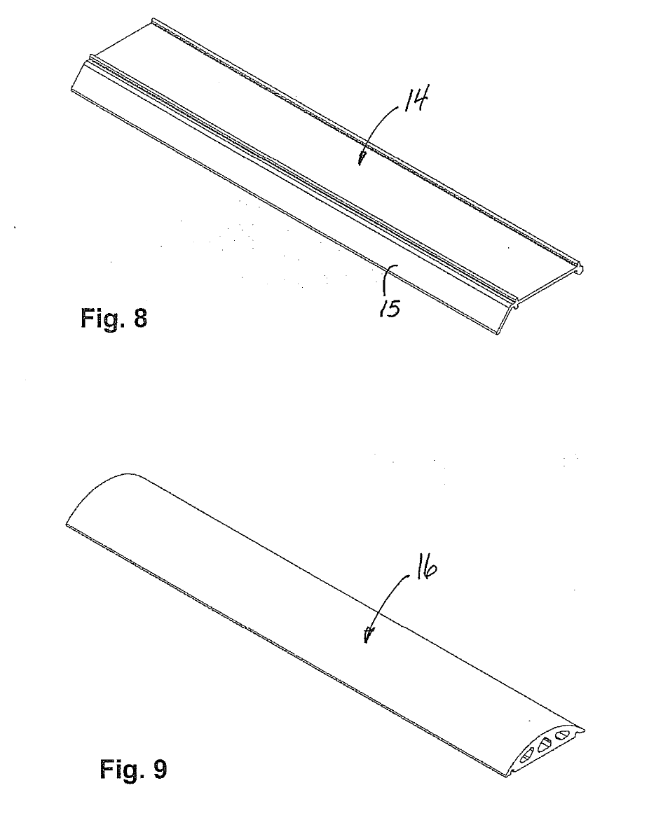

FIGS. 1-9 and 22-24 show a preferred embodiment of a foil application apparatus 2 according to the invention, where an elongated apparatus housing 4 is formed by a longitudinal aluminium profile 6, shown in FIG. 2, in the situation of use right and left end covers 8, 10, shown in FIGS. 3-6, an elongated lid 12, shown in FIG. 7 and a combined pressing face and fixing plate member 14, shown in FIG. 8, with associated pressing body 16, shown in FIG. 9.

The foil application apparatus 2 shown in FIG. 1 is in principle ready for use, as it is made ready for inserting a rolled up foil 19 with a liner 21 (baking paper), of which a free upper edge 37 is fixed in a longitudinal slot 23 between a firm holding edge 25 and the fixing plate member 14, which is spring-biased outwardly, and which in open, inwardly moved position can be fixed by means of locking fingers 22 of end covers 8 and 10.

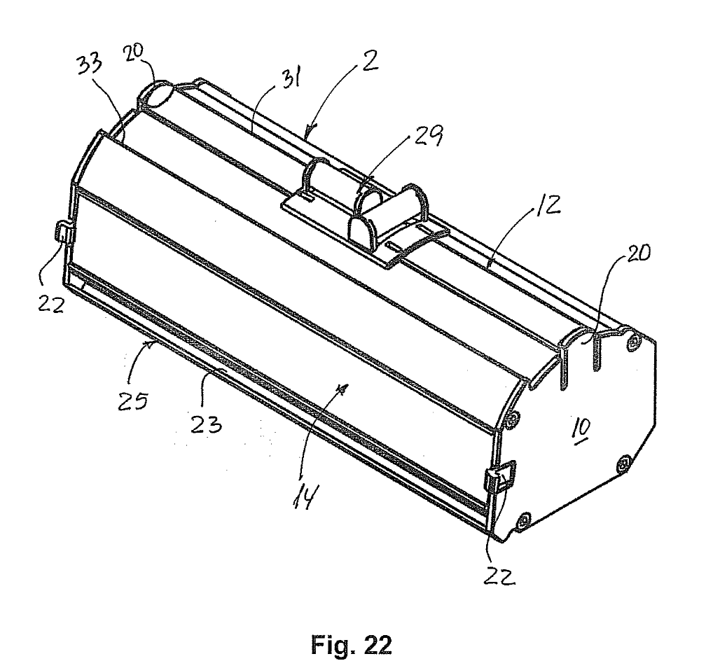

To the left in FIG. 1 the plane top side 27 is in the situation of use, which is used as a guiding means to correctly position the foil application apparatus 2 in the horizontal position, which, however, may be supported by a level system 29 shown in FIGS. 22-24, and which is adapted to be displaced in the longitudinal direction externally on a rail profile part 31 on the lid 12.

The lid 12 is, as shown to the right in FIG. 1, adapted to, by means of an external central part of the rail profile part 31, to interact with resilient locking fingers 20 of the end covers 8 and 10.

At the top in FIG. 1 the foil 19 from a longitudinal outlet aperture 33 along the lid 12 is shown extending across the resilient pressing body 16, which is mounted externally on the combined pressing surface and the fixing plate member 14 to the fixing slot 23. In addition, the pressing body 16 is covered with felt 35.

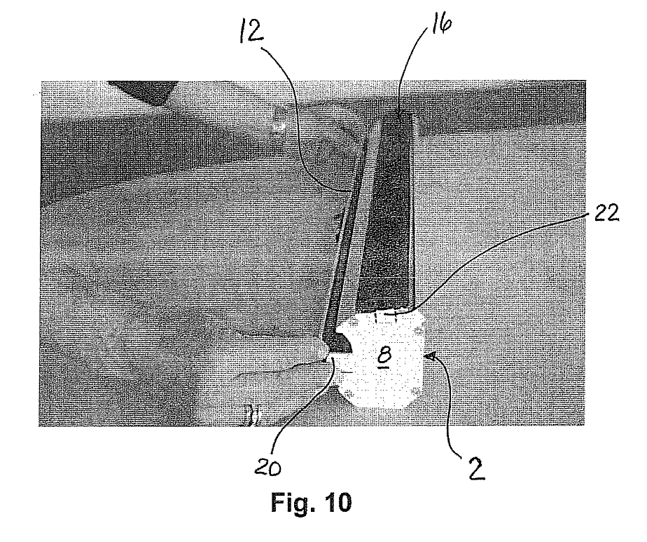

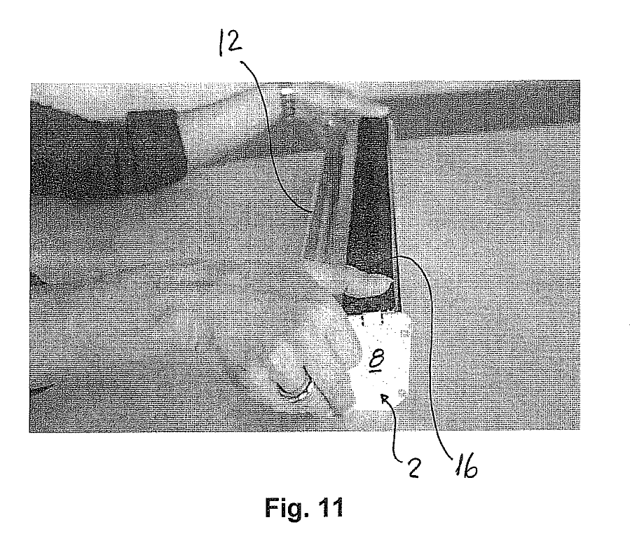

FIGS. 10-21 show step by step how the foil application apparatus 2 is made ready and used for applying a self-adhesive foil 19 on a surface of application.

FIG. 10 shows how the lid 12 is opened over an elongated insertion opening 18 by simultaneously pressing outwards associated locking fingers 20 of end covers 8 and 10.

FIG. 11 shows how the combined pressing face and fixing part 14 with mounted pressing body 16 are pressed inwards and fixed behind associated locking fingers 22 so that a longitudinal slot 24 is opened between a fixing edge 26 of the apparatus housing 4 and the outwards spring-biased fixing part 14.

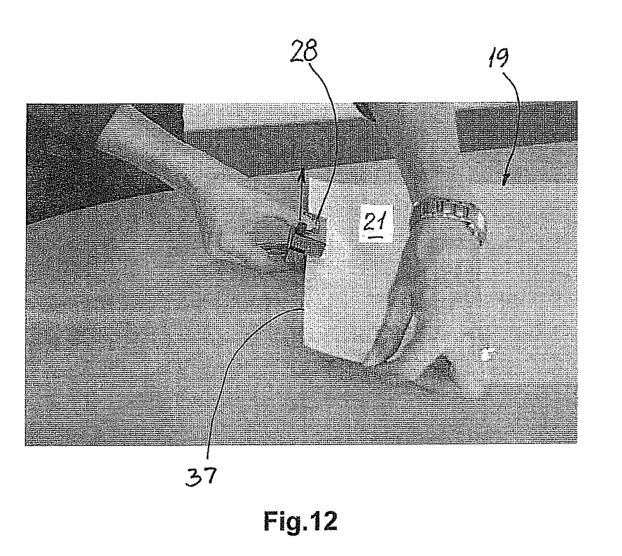

FIG. 12 shows how a transverse cut is performed with a special cutting device 28 in the liner 21 at a short distance from a top side edge 37 of a self-adhesive foil 19.

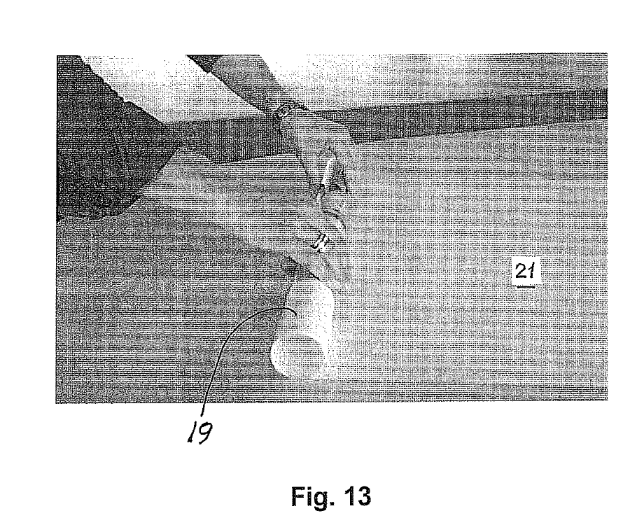

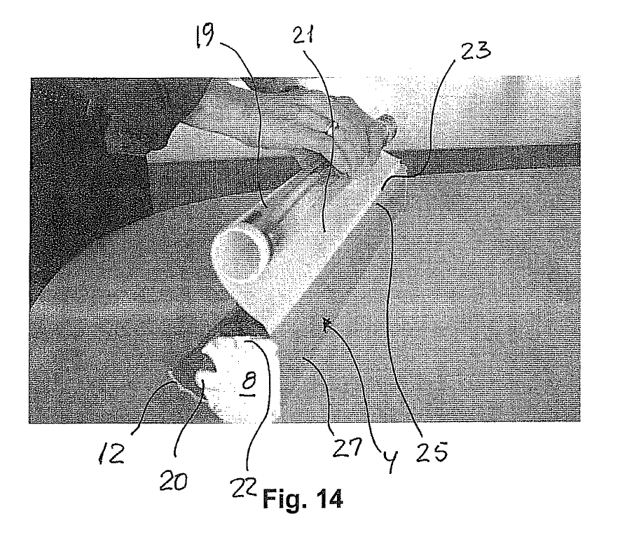

FIG. 13 shows how the foil 19 is rolled into a roll from the bottom and with the print side facing outwards in the roll.

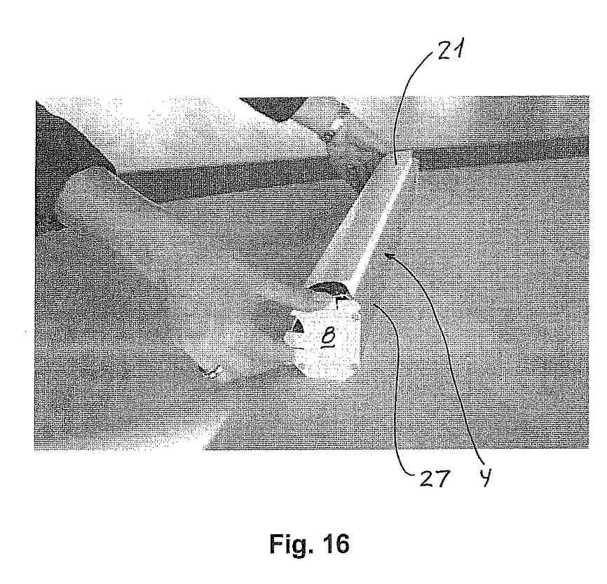

FIG. 14 shows how the free edge 37 of the foil 19 is positioned in the open slot 23 between the fixing edge 25 of the apparatus housing 4 and the outwards spring-biased fixing part and fixed therein, as shown in FIG. 16, by releasing the engagement between the locking fingers 22 of end covers 8 and 10, so that the free end edge 37 of the foil 19 is fixed externally on the apparatus housing 4.

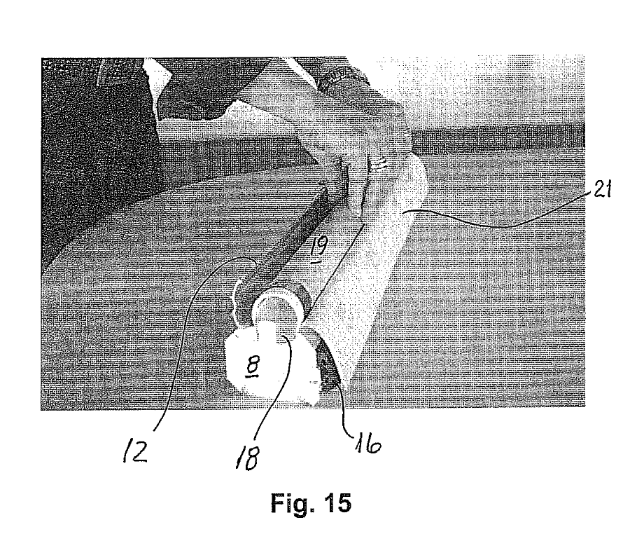

FIG. 15 shows how the foil roll is then inserted in the apparatus 2 through the inlet aperture 18 before the lid 12 is closed and fixed by means of the locking fingers 22 of the end covers 8 and 10.

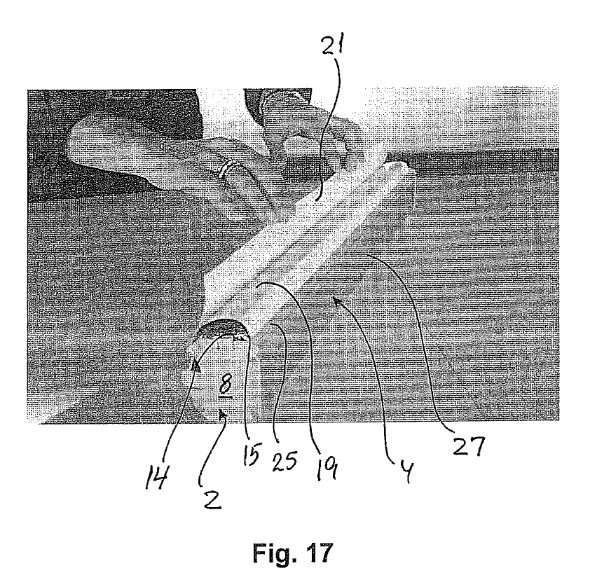

It is checked that the fixing plate member 14, as shown in FIG. 16, is activated as described above before the liner 21, as shown in FIG. 17, is released from the uppermost free part of the foil 19, after which the apparatus 2 is ready for application of the foil 19.

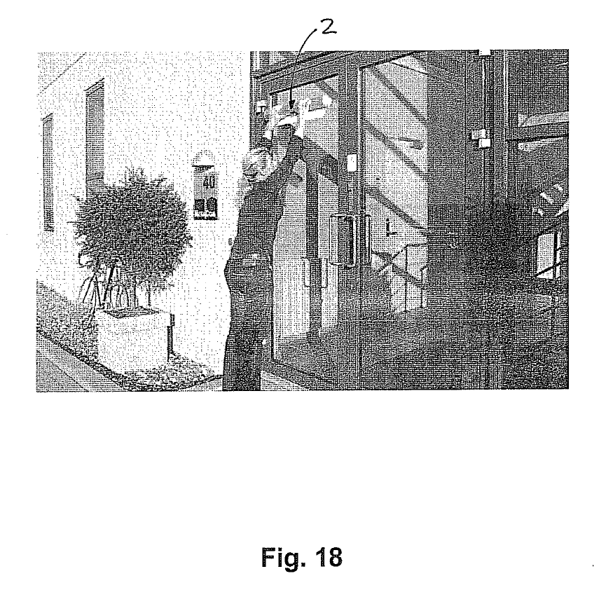

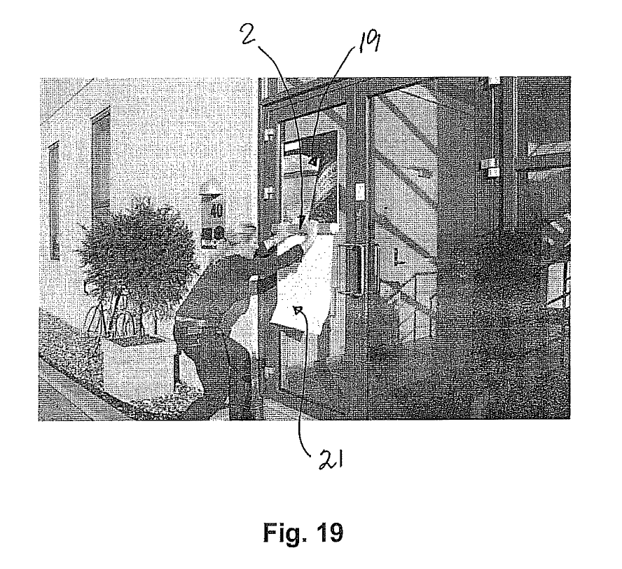

FIG. 18 shows that the apparatus 2 is held in both hands with the lid 12 and possible spirit level system 29 facing downwards so that correct horizontal position may be checked. If possible, one may aim along the plane top side 27 of the apparatus 2 for alignment according to a firm horizontal edge before the pressing body 16 is pressed against the mounting surface, after which the apparatus 2 is moved slowly downwards under continuing pressure, as shown in FIG. 19, until the entire foil 19 is mounted.

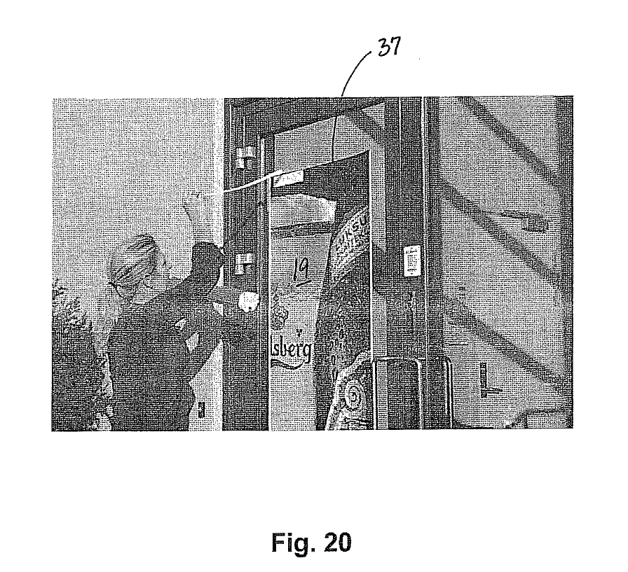

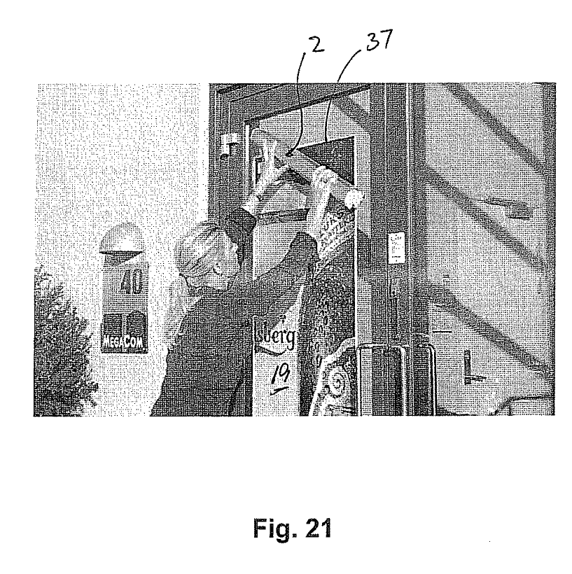

FIG. 20 shows how the narrow liner strip is torn free from the top side edge 37 of the foil 19 before this finally, as shown in FIG. 21, is smoothed by means of the pressing body 16 of the apparatus 2.

FIGS. 22-24 show the foil application apparatus 2 according to the invention before the pressing body 16, which is a rubber profile strip covered with felt, has been mounted externally on the combined pressing surface and fixing plate member 14, for example, by means of Velcro®.

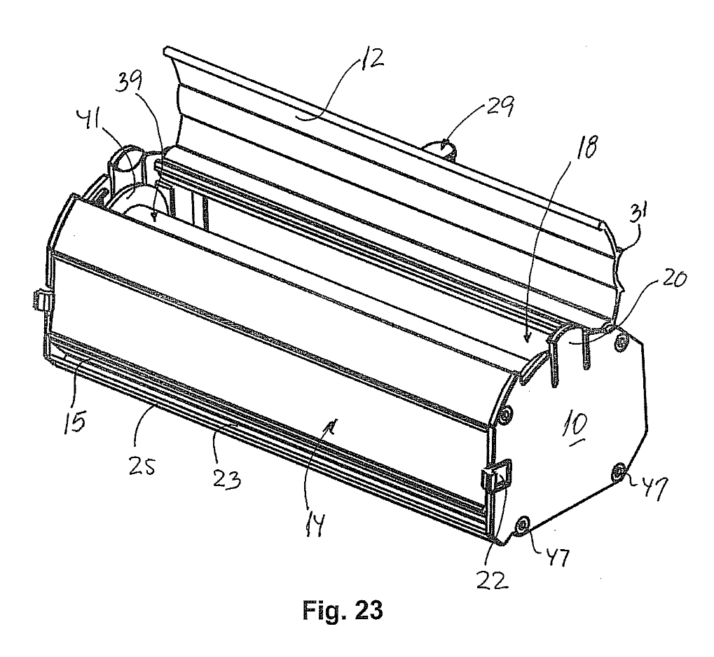

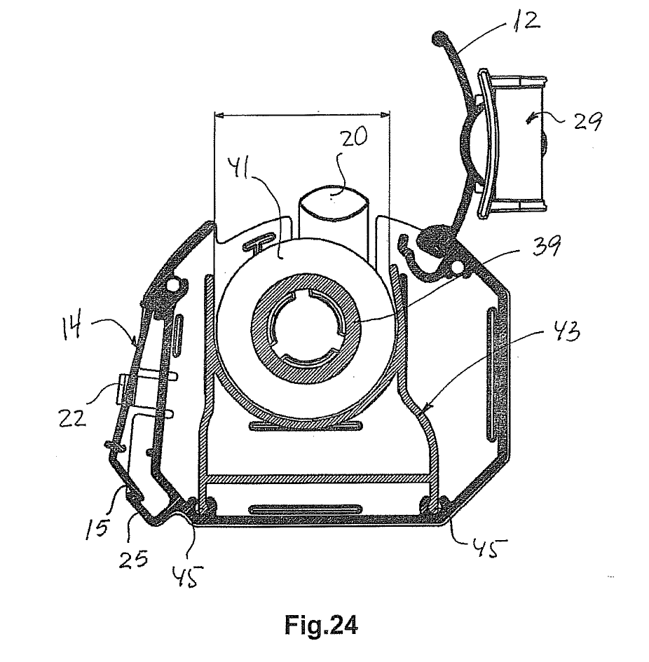

In FIG. 23, the foil application apparatus 2 is seen with open inlet aperture 18 through which a roll 39 in the shape of a cardboard tube with loose end pieces 41 for receiving a rolled up foil 19 can be faintly seen. As it further appears in the sectional view in FIG. 24, the foil application apparatus 2 may, if desired, be provided with bracket-shaped holders 43 which are fixed downwards in internal longitudinal profile grooves 45, and upwards are supporting the end pieces 41 of the cardboard tube roll 39. In general, the internal longitudinal grooves are used for accommodating screws 47 for securing end covers 8 and 10 of the foil application apparatus.

However, it should be noted that the main aspect of the invention, namely the easy method for mounting self-adhesive tape, may of course be performed by means of other apparatuses than those shown and described, as well as it will also be within the inventive concept to produce relatively small application apparatuses in the form of smaller apparatuses for dispensable use, which may possibly also be used as sales packings, that is where an application apparatus already contains a readymade roll with a desired foil poster which may be packed in an outer packing, for example, a plastic bag.

Finally, it should be noted that a main aspect of the invention, namely that the described method and the described apparatus also can be used with great advantage for mounting linerless foils, that is self-adhesive foils where the self-adhesive glue is not covered by a liner. Instead, the front side of the self-adhesive foil has been coated with a suitable anti-seize after printing so that the self-adhesive foil can be rolled up in a roll with the front side of the foil facing outwards, and for use in the present invention, preferably in such a way that the upper part of the image of the foil is disposed outermost in the roll.

Such a foil roll may be rolled up on a tube, for example a cardboard tube, so that the foil roll may be reinforced during the mounting by means of a through-going stick, the opposing ends of which in that case may be used for holding on and for pulling the foil down along the mounting face.

1-10. (canceled)

11. A method for mounting self-adhesive foil on a surface of application with the foil being provided with a liner treated with an anti-seize composition comprising providing a liner spaced away from a free end edge of the foil with a transverse cut therein with the self-adhesive foil being rolled into a roll with a front side of the foil facing outwards in the roll, disposing an upper part of an image on the foil at the free edge of the roll, fixing the free edge of the foil externally on an apparatus of application, inserting the roll of foil in the apparatus of application with a free end of the roll being passed out of the apparatus through an outlet before closing and fixing a lid over an inlet aperture, releasing the liner from the foil below the transverse cut, disposing an upper part of the foil in a desired position of application, providing a guide with a plane top side of the apparatus and transferring the foil with contact pressure against a surface of application while simultaneously moving the apparatus so that the foil is mounted in stretched position on the surface of application as the liner concurrently is released from the foil.

12. A method according to claim 11, wherein the fixing of the free edge of the foil externally on the apparatus is performed by inserting the free edge under a longitudinal edge part, and then clamping the free edge of the foil by a longitudinal edge part of an outwardly spring biased fixing plate member.

13. A method according to claim 12, wherein the fixing plate member is locked at opposite ends with locking fingers that engage over opposite end edges of the fixing plate member, and which are integrated in end covers of a housing so that the free edge of the foil is fixed under the longitudinal edge by the longitudinal edge part.

14. A method according to claim 11, comprising fixing the lid with locking fingers that engage over opposite end edges of the lid which are integrated in end covers of a housing.

15. A method according to claim 11, comprising performing pressing contact pressure against the surface of application with a pressing surface including a material coating on a fixing plate member with the contact pressure being provided by a material disposed between the fixing plate member and the material coating.

16. A method according to claim 12, comprising performing pressing contact pressure against the surface of application with a pressing surface including a material coating on a fixing plate member with the contact pressure being provided by a material disposed between the fixing plate member and the material coating.

17. An apparatus for mounting or applying self-adhesive foil which is provided with a liner treated with anti-seize material, the apparatus comprising a longitudinal housing with a longitudinal inlet aperture for inserting a rolled-up self-adhesive foil which is rolled up with a front side of the foil facing outwards and an upper part of an image on the foil is disposed at a free end edge of the roll, a longitudinal outlet aperture for passing out the free edge of the foil for fixing the free edge of the foil with a fixing device at an external face of the apparatus, a longitudinal edge part about which the foil passes for continuously releasing a liner from the foil, and a face including means for providing simultaneous pressing and smoothing of the foil against a surface of application during movement of the apparatus.

18. An apparatus according to claim 17, wherein the fixing device includes a longitudinal fixed edge part below which the free end edge of the foil is inserted, and a longitudinal edge part interacting therewith an outwardly spring biased fixing plate member.

19. An apparatus according to claim 18, where the fixing plate member is lockable at opposing ends with locking fingers which engage over opposite end edges of the fixing plate member and which are integrated in end covers of the housing.

20. An apparatus according to claim 19, wherein the end covers of the housing include spring biased locking fingers which engage over edges of a lid.

21. An apparatus according to claim 17, comprising a pressing surface including a covering of the fixing plate member which is resilient between the fixing plate member and the covering.
